(19) United States
(12) Patent Application Publication
(10) Pub. No.: US 2020/0349355 A1
(43) Pub. Date: Nov. 5, 2020

(54) METHOD FOR DETERMINING REPRESENTATIVE IMAGE OF VIDEO, AND ELECTRONIC APPARATUS FOR PROCESSING THE METHOD

(71) Applicant: LG ELECTRONICS INC., Seoul (KR)

(72) Inventors: Ji Young HUH, Yongin-si (KR); Jin Sung PARK, Hwaseong-si (KR); Moon Sub JIN, Yongin-si (KR); Ji Hye KIM, Seoul (KR); Beom Oh KIM, Suwon-si (KR)

(73) Assignee: LG ELECTRONICS INC., Seoul (KR)

(21) Appl. No.: 16/850,731

(22) Filed: Apr. 16, 2020

(30) Foreign Application Priority Data
Apr. 30, 2019 (KR) PCT/KR2019/005237

(51) Int. Cl. G06K 9/00

(52) U.S. Cl. CPC G06K 9/00718; G06K 9/00671; G06K 9/00744

(57) ABSTRACT

Provided are a method for determining a representative image of a video with reference to a representative object, and an electronic apparatus for processing the method. A method for determining a representative image of a video may comprise acquiring a video, determining a representative object of the video from at least one object appearing in the video, and determining a representative image of the video on the basis of an image score representing visual importance of the representative object. Accordingly, an image in which a representative object is the most visually conspicuous may be determined as a representative image of a video.

### CROSS-REFERENCE TO RELATED APPLICATION

This present application claims benefit of priority to PCT International Application No. PCT/KR2019/005237, entitled “METHOD FOR DETERMINING REPRESENTATIVE IMAGE OF VIDEO, AND ELECTRONIC APPARATUS FOR PROCESSING THE METHOD,” filed on Apr. 30, 2019, the entire disclosure of which is incorporated herein by reference.

### BACKGROUND

### 1. Technical Field

The present disclosure relates to a method for determining a representative image of a video, and an electronic apparatus for processing the method.

### 2. Description of Related Art

Along with the popularization of smartphones, social media services, such as Facebook™ and Instagram™, have become popular, and service technologies related to multimedia contents are accordingly being actively developed.

In services such as a photo album of a user terminal or a cloud storage service for photos, a video is displayed by its representative image. In these services, a representative image of a video serves as an identifier of the video. The first frame of a video has generally been used as a representative image of the video.

As disclosed in Korean Patent Laid-open Publication No. 10-2019-0006815 A (hereinafter referred to as “related art 1”), entitled “Server and Method for Selecting Representative Image for Visual Contents,” a method for selecting a representative image comprises storing a video formed of sequential images or a panoramic image in a storage device, displaying the stored video or panoramic image on a user terminal according to a request from the user terminal, measuring a time for displaying sections of the video or panoramic image, and selecting one image in a section which has been displayed for a long time, from among the sections, and then displaying the same as a representative image.

However, according to the method for selecting the representative image in related art 1, the image of the section which has been played for a long time is simply selected as the representative image of the video. Accordingly, it is probable that the first frame of the video will be displayed as the representative image, and it is difficult to reflect context of the video (for example, object information appearing in the video).

Korean Patent No. 10-1436325 B1 (hereinafter referred to as “related art 2”), entitled “Method and Apparatus for Configuring Thumbnail Image of Video,” discloses a method for configuring a thumbnail image. In the method, an object selected by a user is configured as a temporary thumbnail image on the basis of a user input selecting at least one object from a list of one or more objects that can be configured as a thumbnail image of a video. In the method, the temporary thumbnail image, to which text information inputted by the user is added, is configured as the representative image of the video.

In the method for configuring the thumbnail image in related art 2, although the thumbnail image is determined by selecting a representative object, a user's pattern or connection with the user cannot be reflected when selecting the representative object. In addition, there is a limitation in that an image in which the representative object is the most visually conspicuous may not be automatically determined as the representative image.

### SUMMARY OF THE DISCLOSURE

One aspect of the present disclosure is to provide a method for automatically determining a representative image of a video, without any user input.

Another aspect of the present disclosure is to determine a representative image by considering user relevance.

Another aspect of the present disclosure is to provide a method for selecting an image in which a representative object of a video is the most visually conspicuous as the representative image of the video.

It will be appreciated by those skilled in the art that aspects to be achieved by the present disclosure are not limited to what has been disclosed hereinabove and other aspects will be more clearly understood from the following detailed description taken in conjunction with the accompanying drawings.

In order to achieve the above aspects, a method for determining a representative image of a video according to one exemplary embodiment of the present disclosure may determine a representative image of a video based on a representative object extracted by analyzing the video.

Particularly, a method for determining a representative image of a video may comprise acquiring a video, determining a representative object of the video from at least one object appearing in the video, and determining a representative image of the video on the basis of an image score representing visual importance of the representative object.

In order to achieve the above aspects, a method for determining a representative image of a video according to one exemplary embodiment of the present disclosure may comprise determining a representative object on the basis of user relevance of an object comprised in a video.

Particularly, determining a representative object may comprise determining the representative object on the basis of user relevance of each object of at least one object comprised in the video.

To this end, user relevance of each object may be determined based on at least one of the frequency of an image, in which each object of the at least one object appears, from among images stored in a gallery of a user, or the number of times the user opens the image in which each object of the at least one object appears.

In order to achieve the above aspects, a method for determining a representative image of a video according to one exemplary embodiment of the present disclosure may comprise determining a representative image on the basis of an image score of a representative object.

Particularly, determining the representative image may comprise dividing a video into at least one similar frame group, determining a representative frame of each similar frame group on the basis of an image score of a representative object, and determining a frame of which the representative object has the highest image score from among the representative frames, as a representative image.

To this end, determining the representative frame may comprise determining the image score for each of at least one frame of an similar frame group, and determining a frame with the highest image score as the representative frame of the similar frame group.

Furthermore, determining the image score may comprise determining the image score of each frame based on at least one of image quality factors or location factors of the representative object.

Aspects which can be achieved by the present disclosure are not limited what has been disclosed hereinabove and other aspects can be clearly understood from the following description by those skilled in the art to which the present disclosure pertains.

In accordance with various exemplary embodiments of the present disclosure, following effects may be achieved.

First, a representative image of a video is determined based on a representative object extracted by analyzing the video, and thus, a representative image may automatically be determined without any user input.

Second, the representative object is determined based on user relevance of an object comprised in a video, and the representative image of the video is determined on the basis of the determined representative object. Thus, a representative image reflecting an interest or intent of a user may be determined.

Third, the representative image is determined on the basis of an image score of the representative object, and thus, an image in which the representative object is the most visually conspicuous may be determined as the representative image of the video.

### BRIEF DESCRIPTION OF THE DRAWINGS

The foregoing and other objects, features, and advantages of the invention, as well as the following detailed description of the embodiments, will be better understood when read in conjunction with the accompanying drawings. For the purpose of illustrating the invention, there is shown in the drawings an exemplary embodiment that is presently preferred, it being understood, however, that the invention is not intended to be limited to the details shown because various modifications and structural changes may be made therein without departing from the spirit of the invention and within the scope and range of equivalents of the claims. The use of the same reference numerals or symbols in different drawings indicates similar or identical items.

FIG. 1 schematically illustrates determination of a representative image according to one exemplary embodiment of the present disclosure.

FIG. 2 is a block diagram of an electronic apparatus for processing a method for determining a representative image according to one exemplary embodiment of the present disclosure.

FIG. 3 is a flowchart schematically showing a process of determining a representative image according to one exemplary embodiment of the present disclosure.

FIG. 4 is a flowchart showing in detail a process of determining a representative image according to one exemplary embodiment of the present disclosure.

FIG. 5 is a drawing to explain determination of a representative object according to one exemplary embodiment of the present disclosure.

FIG. 6 is a drawing to explain determination of a representative object according to one exemplary embodiment of the present disclosure.

FIG. 7 is a flowchart showing a process of determining a representative image according to an additional exemplary embodiment of the present disclosure.

FIG. 8 is a drawing to exemplarily show utilization of a representative image according to one exemplary embodiment of the present disclosure.

### DETAILED DESCRIPTION

Hereinafter, exemplary embodiments of the present disclosure will be described in detail with reference to accompanying drawings, and the same or similar elements are designated with the same numeral references regardless of numerals in the drawings and their redundant description will be omitted. In describing exemplary embodiments of the present specification, moreover, the detailed description will be omitted when a specific description for publicly known technologies is judged to obscure the gist of the exemplary embodiments.

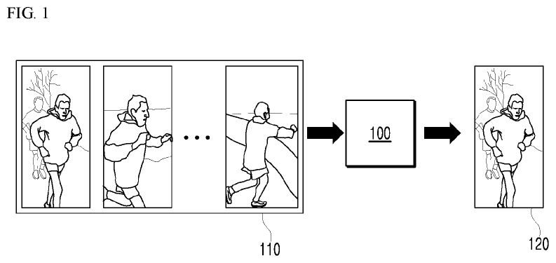

FIG. 1 schematically illustrates the determining of the representative image according to one exemplary embodiment of the present disclosure.

A representative image of a video denotes a frame which is designated to represent the video, from among a plurality of frames of the video, or denotes a reduced or enlarged image of the designated frame. In a photo album of a user terminal, social media, and cloud services for photos, a video is displayed and identified by its representative image.

A method for determining a representative image and an electronic apparatus 100 for processing the method execute a process of determining a representative image according to one exemplary embodiment of the present by receiving a video formed of a sequence of frames. As a result of the execution, at least one representative image, which represents the video, is determined. For example, an exemplary representative image 120 is determined from a sequence of exemplary frames 110 by executing the process of determining a representative image according to one exemplary embodiment of the present.

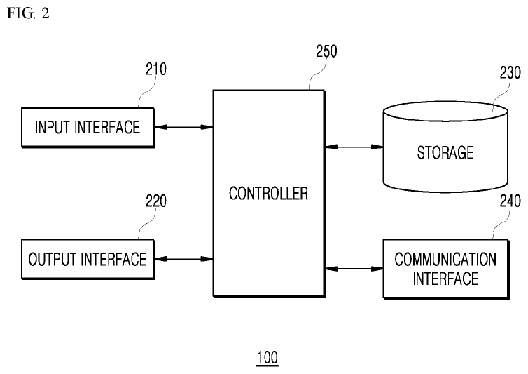

FIG. 2 is a block diagram of the electronic apparatus 100 for processing the method for determining the representative image according to one exemplary embodiment of the present disclosure.

The electronic apparatus 100 for processing the method for determining the representative image (hereinafter referred to as “electronic apparatus 100”), may comprise an input interface 210, an output interface 220, a storage 230, a communication interface 240, and a controller 250250. The elements illustrated in FIG. 2 may be not a requirement for implementing the electronic apparatus 100, and the electronic apparatus 100 described in the present specification may have more or fewer elements than those enumerated above.

Particularly, the input interface 210 may comprise a camera for capturing a video. A video acquired by the input interface 210, such as the camera, is stored in the storage 230 under control of the controller 250250.

The output interface 220 generates an output associated with a visual sense, an auditory sense, or a tactile sense, and the like, and may comprise a display. The display may be configured as a touch screen by forming a layered structure with a touch sensor or by being integrated therewith. The touch screen may provide an output interface 220 between the electronic apparatus 100 and a user, while also providing an input interface 210 between the electronic apparatus 100 and the user.

The communication interface 240 may comprise one or more wired or wireless communication modules which enable the electronic apparatus 100 to communicate with a terminal device provided with any communication modules. The communication interface 240 may comprise a wired communication module, a wireless communication module, a short-range communication module, and the like.

The electronic apparatus 100 may acquire a video from a terminal device via the communication interface 240. For example, the terminal device may be a user device for capturing videos or storing the same. The electronic apparatus 100 may be a server apparatus. The controller 250250 may be configured to acquire a video from a terminal via the communication interface 240, and determines a representative image by processing a process of determining the representative image. The controller 250250 may transmit the representative image to the terminal via the communication interface 240. In this case, the communication interface 240 corresponds to the input interface 210 for receiving the video as well as the output interface 220 for outputting the representative image.

The storage 230 may store the video acquired via the input interface 210 or the communication interface 240. The storage 230 stores various data used for determination of the representative image. For example, the storage 230 may store various application programs or applications ran in the electronic apparatus 100, user information, data for an operation of determining a representative object and data for an operation of determining a representative image, and commands. For example, representative object data may comprise object information related to the user and a learning model used for image captioning. At least some of such application programs may be downloaded through wireless communication. The storage 230 may store the representative image determined for each video.

The controller 250 performs a process of determining the representative image for the video which is acquired via the input interface 210 or the communication interface 240, or is stored in the storage 230. The controller 250 controls the aforementioned elements in various ways. The controller 250 comprised one or more processors. The storage 230 comprises memory that is coupled to the one or more processors of the controller 250 and provides the one or more processors with instructions which when executed cause the one or more processors to process the procedures for determining a representative image for an input video.

Particularly, the controller 250 may acquire the video by controlling the input interface 210 or the communication interface 240, and then store the same in the storage 230. The controller 250 may determine a representative object of the video from at least one object appearing in the acquired video.

For example, the controller 250 may determine user relevance of at least one object appearing in the video, and may determine an object with the highest user relevance as the representative object. For example, the controller 250 may perform image captioning with regard to the representative frame, and may determine, as the representative object, an object comprised in a phrase generated as a result of the image captioning.

The controller 250 may divide the video into at least one similar frame group, and may determine a representative frame of each similar frame group on the basis of an image score representing visual importance of the representative object. The controller 250 may determine a frame of which the representative object has the highest image score from among the representative frames determined for each similar frame group, as the representative image.

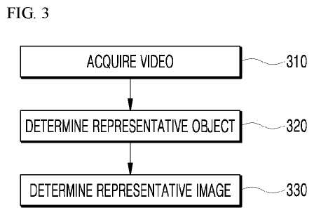

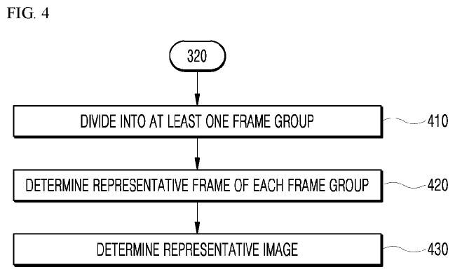

Hereinafter, a process of determining a representative image according to one exemplary embodiment will be described with reference to FIGS. 3 and 4.

FIG. 3 is a flowchart schematically showing a process of determining a representative image according to one exemplary embodiment of the present disclosure.

At a step 310, the electronic apparatus 100 acquires a video of which a representative image should be determined. For example, the controller 250 may acquire a video via the input interface 210 or the communication interface 240. For example, the controller 250 may acquire a storage location of the storage 230 in which the video is stored.

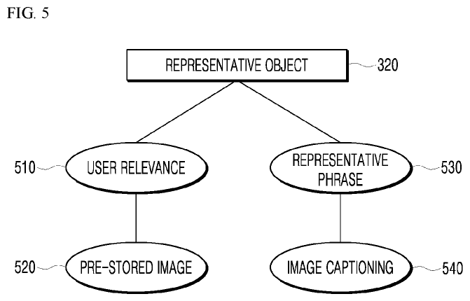

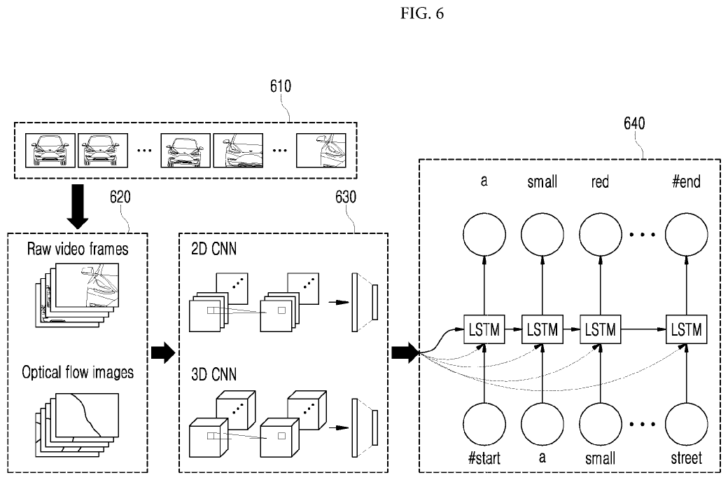

At a step 320, the controller 250 determines a representative object of a video from at least one object appearing in the video. The determination of the representative object will be described in detail below with reference to FIGS. 5 and 6.

At a step 330, the controller 250 determined the representative image of the video on the basis of the image score representing the visual importance of the representative object that is determined at the step 320.

The visual importance of an object denotes a degree to which the object in an image attracts the attention of a viewer. For example, an object displayed in the middle of an image has relatively higher visual importance than an object displayed on the periphery thereof. For example, in an image, a large-sized object has relatively higher visual importance than a small-sized object. For example, in an image, a bright-colored object has relatively higher visual importance than a dark-colored object. For example, in an image, a well-focused object has relatively higher visual importance than a blurred object.

The image score is a relative numerical value of the visual importance of each of at least one object appearing in an image. The controller 250 may determine the image score of the object appearing in the image on the basis of quality factors of the image. Additionally, the controller 250 may determine the image score of the object on the basis of location factors of the object.

At the step 330, the controller 250 determines the image score of the representative object determined at the step 320. The controller 250 may determine the image score of the representative object with respect to each frame of the video. This will be described in detail below with reference to FIG. 4.

FIG. 4 is a flowchart showing in detail the process of determining a representative image according to one exemplary embodiment of the present disclosure.

At a step 410, the controller 250 divides the video, acquired at the step 310 in FIG. 3, into at least one similar frame group.

One similar frame group comprises a consecutive sequence of frames.

At the step 410, the controller 250 may divide the obtained video into at least one similar group, on the basis of similarity between consecutive frames of the video.

For example, at the step 410, the controller 250 may determine a first similarity between a first frame and a second frame, which are sequential frames in a video, and may subsequently determine a second similarity between the second frame and a third frame subsequent to the second frame. When a difference between the first similarity and the second similarity is greater than a predetermined threshold value, the third frame may be determined as a new similar frame group. The new group, to which the third frame belongs, is different from the group to which the first and second frames belong. The controller 250 may set a fixed constant as a threshold value in advance, or may determine an appropriate value for each video.

At a step 420, the controller 250 determines a representative frame of each similar frame group divided at the step 410 on the basis of the image score.

As described above, one similar frame group may comprise at least one frame.

The controller 250 may determine the image score for each of the at least one frame comprised in each similar frame group that is grouped at the step 410, and may determine, as the representative frame of the corresponding similar frame group, a frame of which the image score is determined to be the highest.

The controller 250 may determine the image score of each frame on the basis of at least one of image quality factors and the location factors of the representative object.

The image quality factors are factors related to the quality of an image, such as focus, composition, brightness, blur of the image and so on. The location factors of the representative object are factors that cause attention to be focused on the representative object, such as a location, size, composition of the representative object in the image and so on.

At the step 410, the controller 250 may determine the image score of each frame on the basis of any one of the image quality factors and the location factors of the representative object. Alternatively, the controller 250 may determine the image score of each frame by combining the image quality factors and the location factors of the representative object by using weights thereof. Alternatively, the controller 250 may determine the image score by further reflecting additional factors which affect the visual importance. For example, a frame in which the representative object is fully in focus, without any blur, may be determined as the representative frame.

At a step 430, the controller 250 determines a frame of which the representative object has the highest image score as determined at the step 420, from among the representative frames determined at the step 420, as the representative image.

When a plurality of representative images are determined, the controller 250 may determine one representative image according to a user's selection. Additionally, the controller 250 may suggest an appropriate representative image to the user by learning the preference of the user for selecting one representative image from among the plurality of representative images.

The step 330 in FIG. 3 may comprise steps 410, 420, 430 in FIG. 4.

FIG. 5 is a drawing to explain determination of the representative object according to one exemplary embodiment of the present disclosure.

The controller 250 may determine the representative object at the step 320 on the basis of at least one of user relevance 510 or a representative phrase 530.

The controller 250 may determine the representative object of the video on the basis of user relevance 510 to at least one object appearing in the video.

user relevance of the object is a predictive value of proximity between a certain object and a user. When the user more frequently photographs or opens images related to the certain object, it is predicted that there is a high proximity between the user and the certain object, and thus, user relevance of the certain object becomes higher.

For example, the controller 250 may determine the frequency of an image comprising an object that appears in a video from among pre-stored images 520 stored in a user's gallery, as user relevance of the object. For example, the controller 250 may determine, the number of times the user opens the image comprising an object that appears in the video, from among the pre-stored images 520 stored in the user's gallery, as user relevance of the object.

Particularly, the controller 250 extracts a user-associated object by analyzing the pre-stored images 520 stored in the user's gallery, and searches whether there is any object matching the user-associated object from the at least one object appearing in the video acquired at the step 310, with reference to FIG. 3. In one example, the controller 250 may extract the user-associated object by using a background process.

When objects that match the user-association object are found, the controller 250 may determine, as the representative object of the video, an object which most frequently appears in the pre-stored images 520 stored in the user's gallery, from among the found matching objects. Alternatively, when objects that match the user-associated object are found, the controller 250 may determine, as the representative object of the video, an object which is most frequently viewed from the images comprising the matching objects.

The controller 250 may determine the representative object of the video on the basis of the representative phrase 530 of the video.

The representative phrase 530 is a phrase (caption) expressing characteristics of the video. The controller 250 may determine the representative phrase 530 of the video by performing the image captioning 540 for the video, and may determine an object included in the representative phrase 530 as the representative object. The image captioning 540 will be described in detail below with reference to FIG. 6.

The controller 250 may perform the image captioning 540 for the representative frame, and may determine, as the representative object, the object included in the representative phrase 530 that is generated as a result of the image captioning.

In another example, the controller 250 may perform the image captioning 540 for each frame of the similar frame group of the video, and may determine, as the representative object, an object which is most often included in the representative phrase 530 generated as the result of the image captioning.

FIG. 6 is a drawing to explain the determination of the representative object according to one exemplary embodiment of the present disclosure.

The controller 250 may perform the image captioning by utilizing, for example, a convolutional neural network (CNN) and a recurrent neural network (RNN).

The controller 250 acquires the video illustrate in FIG. 6. In an exemplary video, a red car is approaching on the road as shown in box 610.

The controller 250 extracts a sequence of raw video frames, exemplarily illustrated in box 620 from the video shown in box 610, and provides the same as an input to 2D CNN or 3D CNN exemplarily shown in box 630. For example, the controller 250 may extract a sequence of optical flow images, exemplarily illustrated in box 620 from the video shown in box 610. Results of the 2D CNN or 3D CNN of box 630 are provided to long short-term memories (LSTMs) exemplarily illustrated in box 640 through mean pooling/soft-attention processes, and then a representative phrase 530 of the video is generated.

When it is required to reflect velocity variance of the object captured in the video, optical flow images, shown in box 620, may be additionally extracted, and information on movement and velocity may be reflected in the phrase by utilizing 3D CNN shown in box 630 of FIG. 6.

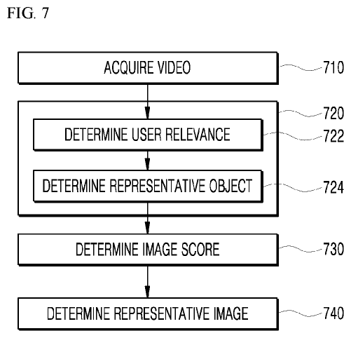

FIG. 7 is a flowchart showing the process for determining the representative image according to an additional exemplary embodiment of the present disclosure.

At a step 710, the electronic apparatus 100 acquires a video of which a representative image should be determined. For example, the controller 250 may acquire the video via the input interface 210 or the communication interface 240. For example, the controller 250 may acquire a storage location of the storage 230 in which the video is stored.

At a step 720, the controller 250 determines the representative object of the video from at least one object appearing in the video.

The step 720 may comprise a step 722 for determining user relevance and a step 724 for determining the representative object on the basis of the user relevance.

Particularly, at the step 722, the controller 250 determines user relevance of each object of at least one object appearing in the video. As described above, the controller 250 may determine the user relevance of an object on the basis of at least one of the frequency of the image which comprises the object appearing in an input video from among the pre-stored images 520 stored in the user's gallery, or the number of times the user opens the image comprising the object appearing in the input video.

At a step 724, the controller 250 determines the object with the highest user relevance as the representative object of the video.

At a step 730, the controller 250 determines the image score representing the visual importance of the representative object on the basis of at least one of the image quality factors or the location factors of the representative object.

At a step 740, the controller 250 determines the representative image of the video on the basis of the image score determined at the step 730.

At the step 740, the controller 250 may divide the input video into at least one similar frame group, determine the representative frame of each similar frame group on the basis of the image score, and determine, as the representative image, a frame of which the representative object has the highest image score from the at least one determined representative frame.

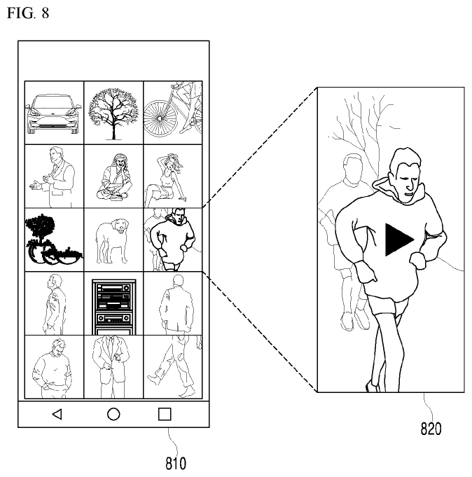

FIG. 8 is a drawing to exemplarily show utilization of a representative image according to one exemplary embodiment of the present disclosure.

As illustrated in box 810, in a gallery of a user terminal, videos may be displayed by their representative images or thumbnail images, which are reduced versions of representative images. That is, the videos are identified by their representative images.

When a user selects a representative image in the gallery, the representative image as shown in box 820 may be displayed on a full screen, and a right-pointing triangular icon, which represents a play button, may be displayed by being superimposed on the center of the representative image.

Meanwhile, the above-described present disclosure may be configured as computer-readable codes in a medium having a program recorded thereon. The computer-readable media comprise all kinds of recording apparatuses having data stored thereon which can be read by a computer system. Examples of the computer-readable media may comprise hard disk drives (HDDs), solid state disks (SSDs), silicon disk drives (SDDs), ROM, RAM, CD-ROM, magnetic tapes, floppy discs, optical data storage devices, and the like. In addition, the computer may comprise the controller 250 of the electronic apparatus 100.

While the specific exemplary embodiments of the present disclosure have been described above and illustrated, it will be understood by those skilled in the art that the present disclosure is not limited to the described exemplary embodiments, and various modifications and alterations may be made without departing from the spirit and the scope of the present disclosure. Therefore, the scope of the present disclosure is not limited to the above-described exemplary embodiments, but shall be defined by the technical thought as recited in the following claims.

What is claimed is:

1. A method for determining a representative image of a video, comprising:
acquiring a video;
determining a representative object of the video from at least one object appearing in the video; and
determining a representative image of the video on the basis of an image score representing visual importance of the representative object, the determining the representative image comprising:
dividing the video into at least one similar frame group;
determining a representative frame of each similar frame group on the basis of the image score; and
determining, as a representative image, a frame of which the representative object has the highest image score from among the representative frames.

2. The method according to claim 1, wherein the determining the representative object comprises:
determining the representative object on the basis of user relevance of each object of the at least one object.

3. The method according to claim 2, wherein the user relevance of each object is determined on the basis of at least one of the frequency of an image in which each object appears or the number of times the user opens an image in which each object appears, from among images stored in a gallery of a user.

4. The method according to claim 1, wherein the determining the representative object comprises:
performing image captioning for the representative frame; and
determining, as the representative object, an object included in a phrase generated as a result of the image captioning.

5. The method according to claim 1, wherein the similar frame group comprises a consecutive sequence of frames.

6. The method according to claim 1, wherein the dividing comprises:
dividing the video into at least one similar frame group on the basis of similarity between consecutive frames of the video.

7. The method according to claim 6, wherein the dividing comprises:
determining a first similarity between a first frame and a second frame, which are sequential in the video;
determining a second similarity between the second frame and a third frame subsequent to the second frame; and
determining the third frame as a new similar frame group based on difference between the first similarity and the second similarity.

8. The method according to claim 1, wherein the similar frame group comprises at least one frame, and the determining the representative frame comprises:
determining the image score for each of the at least one frame; and
determining a frame with the highest image score as the representative frame of the similar frame group.

9. The method according to claim 8, wherein the determining the image score comprises:
determining the image score of each frame on the basis of at least one of image quality factors or location factors of the representative object.

10. The method according to claim 1, wherein the representative image comprises a plurality of the representative images, and the determining the representative image comprises:
selecting one representative image from the plurality of the representative images according to the user's selection.

11. A method for determining a representative image of a video, comprising:
acquiring a video;
determining a representative object of the video from at least one object appearing in the video;
determining an image score representing visual importance of the representative object on the basis of at least one of image quality factors or location factors of the representative object; and
determining a representative image of the video on the basis of the image score,
wherein the determining the representative object comprises:
determining user relevance of the at least one object; and
determining an object with the highest user relevance as the representative object.

12. The method according to claim 11, wherein the user relevance of each object is determined on the basis of at least one of the frequency of an image in which each object appears or the number of times a user opens an image in which each object appears, from among images stored in a gallery of the user.

13. The method according to claim 11, wherein the determining the representative image comprises:
dividing the video into at least one frame group;
determining a representative frame of each similar frame group on the basis of the image score; and
determining, as a representative image, a frame of which the representative object has the highest image score from among the representative frames.

14. An electronic apparatus comprising:
a storage configured to store a video; and
a controller configured to process operations of:
determining a representative object of the video from at least one object appearing in the video;
dividing the video into at least one similar frame group;
determining a representative frame of each similar frame group on the basis of an image score representing visual importance of the representative object; and
determining, as a representative image, a frame of which the representative object has the highest image score from among the representative frames.

15. The electronic apparatus according to claim 14, wherein the controller is further configured to process operations of:
determining user relevance of the at least one object; and
determining an object with the highest user relevance as the representative object.

16. The electronic apparatus according to claim 14, wherein the controller is further configured to process operations of:
performing image captioning for the representative frame; and
determining, as the representative object, an object included in a phrase that is generated as a result of the image captaining.
